(19) United States
(12) Patent Application Publication
(10) Pub. No.: US 2005/0171881 A1
(43) Pub. Date: Aug. 4, 2005

(54) Financial data analysis tool

(75) Inventors: Mohammad R. Ghassemieh, London (GB); Philip N. Lawlor, London (GB)

Correspondence Address: DARBY & DARBY P.C., P. O. BOX 5257, NEW YORK, NY, 10150-5257, US

(73) Assignee: Nomura International plc, London (GB)

(21) Appl. No.: 11/045,429

(22) Filed: Jan. 28, 2005

(30) Foreign Application Priority Data
Jan. 30, 2004 (GB) 0402109.3

(51) Int. Cl. G06F 17/60

(52) U.S. Cl. 705/35

(57) ABSTRACT

A method and system allowing a user to interrogate external financial data quickly and efficiently and to drill up or drill down and across multiple graphical displays (“maps”) of information. Maps offer multiple dimensional filtration functionality enabling a comparison between different investment strategies. External financial data is received and calculations can be performed on the external financial data to generate one or more indicators. Internal financial data is calculated from one or more of the external financial data and the indicators. Filters are applied to the external and internal financial data, and the indicators. The filtered data is used to generate maps of certain data usually plotted against external and internal financial data or indicators. Icons are generated adding another dimension to the map without adding an additional axis of data. Further “depth” to a map can be added by generating a sub-map or a historical movement map.

### RELATED APPLICATIONS

The present application claims priority under 35 U.S.C. §119 to Great Britain Patent Application No. 0402109.3 filed on Jan. 30, 2004. The content of the Great Britain application is incorporated herein by reference in its entirety.

### FIELD OF THE INVENTION

The present invention relates to a method and system for analyzing, handling, and displaying financial data. More specifically, the present invention provides a method to analyze and sort financial data so that the financial data can be interpreted by a user more effectively.

### BACKGROUND OF THE INVENTION

In recent years, there has been a substantial increase in the use of computers in financial institutions which has resulted in a large increase in the quantity of available financial data. In addition, the availability of the Internet has allowed customers of financial institutions easy access to the financial data.

Often, the financial data is used to buy and sell assets (e.g. stocks, bonds, equities, and commodities), for example stock in companies which may be publicly listed on a stock market. In order to trade stock effectively, it is important to have access to financial data concerning companies in which stock is being traded. This way, an effective trading decision can be made about the value of the stock and how well it will perform in the future.

There are many variables of financial data which can be used to make an effective trading decision. Such variables are indicators, for example, Relative Strength Index (RSI), Earnings Momentum (EMOM), and Moving Average Convergence Divergence (MACD). Variables can be generated for each tradable asset (e.g. a particular stock) or groups of tradable assets (e.g. groups of stocks). Examples of groups of traded stocks are a sector of traded stock (e.g. software, banks, and pharmaceuticals) or geographical regions of traded stock (e.g. U.S., Europe, and Asia).

Currently, financial data for each tradable asset or group of tradable assets is listed in a table. Sometimes, two-dimensional graphs of the variables of a particular asset as a function of time may be produced and displayed on a display screen of a computer. Two-dimensional graphs typically do not display additional data on the same graph, illustrating additional variables, without an additional axis.

Recently, it has become possible to obtain financial data in this way directly from the financial institutions over the Internet and view tables or graphs at a client terminal.

Often, there is so much financial information available for each asset or group of assets that it becomes very difficult to assess the current strength of the market and anticipate the future directional shifts of traded assets and thereby decide which assets should be bought or sold.

One example of graphical data analysis tools is a “heatmap.” U.S. Patent Publication 2004/0148247 to Miller et al. (hereinafter “Miller”) describes a heatmap as a graphical display of cells. Each cell is located, sized and color coded to represent a variable of financial information. Each cell typically represents a single asset. For example, one cell for each publicly traded company on a stock exchange. Miller's cells are typically grouped by industry sector (pharmaceuticals, utilities, etc.) and the size of the cell denotes the size of the company issuing the asset. The color, i.e. temperature, of the cell denotes it economic performance. A user can move “down” through the data on a heatmap to get more specific data on either the company or the industry sector.

However, a heatmap has a number of limitations. A heatmap is typically a fixed snapshot of the market as it stands any particular moment, thus it does not readily show a history of either the industry sector or the individual asset as time progressed. Movement of either the sector or the asset is a very important factor in investing.

Further, a heatmap does not analyze industry sectors in relation to each other. For example, a broad comparison of whether pharmaceuticals or utilities are a better investment is not analyzed or displayed. The closest approximation is the predominant temperature of the cells in an industry sector grouping. However, that is not an indication of how the sector as a whole is performing relative to other industry sectors with similar predominant temperatures.

Also, a heatmap does not offer filters that allow a user to filter the data against numerous variables (e.g., RSI, EMOM, MACD) and cannot filter the data as the user moves “up” or “down” through the financial data. Additionally, the heatmap just graphically presents the “temperature” and size of the asset, but cannot analyze and filter the data to present market trends. Heatmaps typically analyze data against a small number of factors (e.g., typically two or three indicators at most) and present, at best, a one or two dimensional market view. Typically, a heatmap does not plot the assets in relation to any market factors, but just plots a one-dimensional view of the value of the asset at a given moment in time.

It is therefore an aim of the present invention to provide a method and system which allows financial data pertaining to financial assets to be easily compared.

It is a further aim of the present invention to provide a method and system which allows categorized financial data to be accessed more effectively.

Another aim of the present invention is to provide an interactive tool that packages financial data from multiple sources, filters, analyzes and interprets the data against a wide range of indicators, and presents the outputs in a graphic format (i.e. a ‘map’).

A further aim of the present invention is to filter and analyze financial data against multiple indicators and cross-reference the data in a way that generates insightful investment messages. The present invention allows for the quick and efficient identification of market anomalies, wherein lies potential Alpha Generation opportunity (i.e. superior return over market averages).

### SUMMARY OF INVENTION

In accordance with the aforementioned aims, the present invention is described in the appending claims.

In particular, in an aspect of the present invention, there is provided a processing unit; a display screen connected to the processing unit; and manipulation means connected to the processing unit, wherein the processing unit is configured to generate a user interface on the display screen including a visual representation of financial data, wherein a plurality of first icons are arranged in the visual representation, each first icon representing a category of financial data and operable to be activated by the manipulation means, the arrangement of each first icon in the visual representation corresponding to first financial data associated with the category represented by each first icon, wherein on activation of an icon the processing unit is configured to modify the visual representation such that second financial data corresponding to the category of the activated icon other than the first financial data represented in the arrangement of the first icons is displayed in the visual representation. The category of financial data may be representative of a particular tradable asset or a group of tradable assets, categorized according to their industry sector or geographical origin. For example, the present invention enables multivariate financial data to be displayed in an easily interpretable way for single assets or groups of assets. In particular, more than two variables can be accessed and displayed for each particular category.

In one embodiment of the present invention, the second financial data is displayed in a data component corresponding to the activated icon. The data component may be an alphanumeric representation of the second data, for example a table containing the second financial data. This way, first financial data for a particular category can be easily interpreted in the visual representation and additional second financial data can be accessed through the user interface.

In another embodiment of the present invention, the second financial data is represented by a plurality of second icons plotted in the visual representation on activation of a first icon, each second icon corresponding to a sub-category of financial data in the category corresponding to the activated first icon. This way, all the multivariate financial data for a particular category can be viewed in the visual representation according to its arrangement and thus easily interpreted. Advantageously, only the second icons may be displayed in the visual representation on activation of an icon.

Preferably, each category of financial data represented by the icons can be distinguishable by the color, size and/or shape of each icon.

Advantageously, the visual representation may be a graphical representation. The graphical representation may be a multi-dimensional graphical representation. In addition, the graphical representation may be a multi-tier graphical representation.

The graphical representation may comprise a plurality of segments in which icons are plotted, each segment representing the attributes relating to financial data corresponding to the icons plotted in each segment. Preferably, the segments are quartiles of the graphical representation. In addition, the graphical representation may comprise a plurality of axes. The segments may be distinguished from each other by color or with labels. This way, a quick comparison can be made between assets which are, for example, attractive/unattractive, fall into a valuation trap or need to be re-rated, reliable buys/sells or potential sells/risky buy.

Preferably, the plurality of axes includes: a first axis corresponding to a first measurement of financial data; and a second axis corresponding to a second measurement of financial data, wherein the first icons are plotted against the first axis and the second axis according to the first measurement and the second measurement of the first financial data corresponding to the first icons. Additionally, the second icons can be plotted against the first axis and the second axis according to the first measurement and the second measurement of the second financial data corresponding to the second icons.

An embodiment of the present invention, a plurality of first icons represents a single category of financial data, each first icon representing the financial data corresponding to the single category at a specific time. The plurality of first icons representing a single category of financial data can be linked by a line in time order. Additionally, a plurality of second icons represents a single sub-category of financial data, each second icon representing the financial data corresponding to the single sub-category at a specific time. The plurality of second icons representing a single category of financial data can be joined in time order. Thus, the history of a particular category of first and/or second financial data can be viewed and easily interpreted.

Each category of financial data may be representative of a particular tradable asset or a group of tradable assets, categorized according to their industry sector or geographical origin. Each category of data can correspond to a country from which financial data is acquired. Further, each sub-category of data can correspond to an industry in a country from which financial data is acquired in a category corresponding to the country.

The manipulation means may be a pointing device, such as a mouse, or other device such as a keyboard. Alternatively, the manipulation means may be integrated into the display screen as a touch screen operated by a user's finger or other implement.

In another aspect of the present invention, there is provided a system for analyzing financial data comprising: a server processing unit storing financial data; a client processing unit connected to the server processing unit; a display screen connected to the client processing unit; and manipulation means connected to the client processing unit, wherein the client processing unit generates a user interface on the display screen including a visual representation of first financial data received from the server processing unit, the visual representation comprising a plurality of first icons, each first icon representing a category of the first financial data and operable to be activated by the manipulation means, the arrangement of each first icon in the visual representation corresponding to first financial data associated with the category represented by the each first icon, wherein on activation of an icon the client processing unit requests second financial data from the server processing unit corresponding to the category of the activated icon other than the first financial data represented in the arrangement of the first icons and displays the second financial data in the visual representation. The server and client processing units may be connected across the Internet and the user interface may be a web browser.

In one embodiment of this aspect of the present invention, the financial data received from the server processing unit by the client processing unit is raw financial data and the client processing unit is adapted to generate the visual representation from the raw financial data.

In an alternative embodiment of the present invention, the financial data received from the server processing unit by the client processing unit is graphical data including the visual representation and the client processing unit is adapted to display the visual representation from the graphical data in the user interface.

A further aspect of the present invention, there is provided a user interface comprising: a visual representation of financial data; a plurality of first icons arranged in the visual representation, each first icon representing a category of financial data and operable to be activated by a pointing device, the arrangement of each first icon in the visual representation corresponding to first financial data associated with the category represented by the each first icon, wherein activation of an icon modifies the visual representation such that second financial data corresponding to the category of the activated icon other than the first financial data represented in the arrangement of the first icons is displayed in the visual representation.

Another aspect of the present invention, there is provided a method of handling financial data, comprising the steps of: displaying a plurality of icons in a visual representation on a display unit, each icon corresponding to a category of financial data, the arrangement of each icon in the visual representation corresponding to first financial data associated with the category represented by the each icon; and on activation of one of the icons with a pointing device, modifying the visual representation such that second financial data corresponding to the category of the activated icon in addition to the first financial data represented in the arrangement of the icons is displayed in the visual representation.

Furthermore, the present invention provides a computer program for handling financial data, comprising: first instructions executable on a computer to generate on a display screen a user interface having displayed therein: a visual representation of financial data; and a plurality of icons arranged in the visual representation, each icon representing a category of financial data and operable to generate a control signal on activation by a pointing device, the arrangement of each icon in the visual representation corresponding to first financial data associated with the category represented by the each icon; second instructions executable on the computer to trigger the computer to respond to generation of the control signal; and third instructions executable in response to generation of the control signal to modify the visual representation such that second financial data corresponding to the category of the activated icon in addition to the first financial data represented in the arrangement of the icons is displayed in the visual representation.

Another aspect of the present invention, there is provided a carrier comprising the computer program hereinbefore described. The carrier may be removable media, such as optical disks (e.g., DVD, CDROM) or floppy disks. Alternatively, the carrier may be fixed memory such as ROM or hard disk.

A further aspect of the present invention, there is provided a computer executing the computer program hereinbefore described.

Another aspect of the present invention is to allow a user to interrogate external financial data quickly and efficiently and to drill up or drill down and across multiple graphical displays (“maps”) of information, i.e. from the top down (e.g., macro/asset level, geographic regions/markets, sectors) and/or from the bottom up (e.g., stock level) and to filter the data against indicators (e.g., RSI, EMOM, and MACD). The maps offer multiple dimensional filtration functionality enabling a comparison between different investment strategies (e.g., growth versus value approach). Each filter or group of filters of requested indicators applied by the user can cause a recalculation the data for any given map or sub-map of information. Users can visualize the market rotation prevailing in their areas of investment interest and quickly identify market anomalies, (for example, inflection/turning points, outliers, and catalysts of change).

Further, an aspect of the invention is a method by which the external and internal financial data are input and processed. External financial data is received from a third-party provider and relates to, for example, trading information on individual assets from one or more markets both national and international, market information and indices, and other financial indicators (e.g., interest rates, inflation, unemployment, crop reports, and weather trends).

The external financial data can include, for example, up to the minute asset prices from any or all of the world markets, the Dow Jones Industrial Average, the Standards and Poor's 500 Index (S&P 500), and information from reporting agencies.

Calculations can be performed on the external financial data to generate one or more indicators. The ROE, EMOM, RSI, MACD, PBR, and LTIG are examples of indicators calculated for at least the asset, sector, nation, region, and market, as applicable. Calculations for certain indicators, e.g., PBR, are uniform. Calculations for other indicators, e.g., ROE, RSI and MACD, can vary depending on the view of the organization performing the calculation. The basic formula typically remains the same, however, additional factors or changing the length of time over which asset information is included alters the results. Internal financial data is calculated by proprietary calculations of the specific organization and can be generated from one or more of the external financial data and the indicators.

Filters are applied to the external and internal financial data, and the indicators. Filters sort the financial data and the indicators into numerous categories. For example, a Macro Filter accumulates GDP, inflation and interest rate information. A Valuation Filter sorts ROE, PBR and LTIG and an Earnings Filter sorts EMOM and the up and down movement of the asset. A Technical Filter sorts RSI, MACD and Stochastic information. A macro economic filter can also be applied to the filters. The macro economic filters can apply both known and assumed conditions and predictions to further filter the data.

The filtered data is used to generate visual representations (maps) of certain data usually plotted against external and internal financial data or indicators. Typical maps are a Valuation Map, an Earnings Map, a Macro Map, a Technical Map, a Corporate Bond map and an Ideas Map. One or more maps can be generated for any asset, sector, or market at the national, regional, or global level. For example, the national markets in one or more regions (North America, Europe, Asia) or countries can be plotted together, the same sector globally can be plotted together (e.g. the steel industry in the U.S. as compared to the steel industry in Great Britain and Japan), and sectors can be plotted against each other (e.g. software and steel).

Furthermore, to generate the map of one type of data verse another, the individual icons can be color, shape, and/or size coded with additional data, for example the range of MACD between −3 and 3 can represent a range of colors, to add to the data displayed on the user interface. The icon adds another dimension to the map without adding an additional axis of data. An embodiment allows three or more different combinations of external and internal financial data and indicators to be plotted on a two-dimensional map.

Further “depth” to a map can be added by generating a sub-map. Once a map is generated, sub-maps can be generated automatically or upon user request and typically contain more detailed or focused information than the initial map. The sub-maps can contain “raw” data. A sub-map is the next map requested by a user after an initial map is selected. For example, if the user selects an Earnings Map comparing world markets, the use can select an Earnings sub-map of an individual country or region. The country or region sub-map is also a map a user could have selected initially and the user is not necessarily required to select one type of map to get to a sub-map.

The map is a multi-dimensional representation of financial data and the user can “drill down” through any map to get further analysis and all the way down to the raw data that generated the icon.

Another aspect of the invention is a method to generate a historical movement map. The user selects an icon for which the user wants historical movement information. Part of the user selection includes how far into the past historical information is required (e.g., 10 years, 3 months, 1 month, the previous week, or daily).

One or more historical icons are generated using the historical data and plotted on the requested historical map. The icons can represent multiple time periods that require additional calculations further than just retrieving the necessary data from the storage database.

Historical time lines connect the historical icons in time order, for example, from oldest to youngest. The lines indicate the direction the asset “traveled” in the historical map to arrive at its current position on the map.

To clarify the exact historical path, a moving pointer can be generated to move from the oldest historical icon, across the lines, to the most recent icon. This provides a visual representation of the movement of the icon.

A further aspect of the invention is a method to compare a user's existing portfolio of assets against the performance of the market or sector as a whole or against their own assets. The user selects a group or portfolio of assets. The user can select a mix of assets to place in a portfolio, or the portfolio can be automatically generated given the nature of the assets in the portfolio and the standard categories the assets are defined in.

The user selects which markets to which the portfolio should be compared and the user also can define an outlier ratio that defines the proportion of assets that are outliers on a map.

The user selects the type of map to generate and the system generates the portfolio map using the portfolio, market and outlier information. The icons related to the portfolio assets can be a specific color, shape or size, while the icons representing assets not in the portfolio can have a different color, shape, or size. Portfolio sub-maps can also be generated automatically or upon user request. All of the information available on any of the non-portfolio maps can be provided in the portfolio map, including drill downs to more specific data and historical movement maps.

### BRIEF DESCRIPTION OF THE DRAWING FIGURES

The above and still further objects, features and advantages of the present invention will become apparent upon consideration of the following detailed description of a specific embodiment thereof, especially when taken in conjunction with the accompanying drawings wherein like reference numerals in the various figures are utilized to designate like components, and wherein:

FIG. 1a illustrates an embodiment of the system according to the present invention;

FIG. 1b shows an embodiment of data processing hardware implemented in the system of FIG. 1a;

FIG. 2a illustrates an embodiment of a user interface implemented by the system of FIGS. 1a and 1b;

FIG. 2b illustrates another embodiment of the user interface implemented by the system of FIGS. 1a and 1b.

FIG. 3 shows a sub-map embodiment of the user interface implemented by the system of FIGS. 1a and 1b;

FIG. 4 shows a historical movement embodiment of the user interface implemented by the system of FIGS. 1a and 1b;

FIG. 5 is a flow chart illustrating a method of generating a map of the present invention;

FIG. 6 is a flow chart illustrating an alternate method to generate a map of the present invention;

FIG. 7 is a flow chart illustrating a method to generate a sub-map of the present invention;

FIG. 8 is a flow chart illustrating an alternate method to generate a map of the present invention;

FIG. 9 is a flow chart illustrating a method of generating a historical movement map of the present invention;

FIG. 10 is a flow chart illustrating a method of generating a portfolio map of the present invention; and

FIG. 11 illustrates an exemplarily portfolio map user interface of the present invention.

### DETAILED DESCRIPTION OF THE PREFERRED EMBODIMENT

Definitions

The terms used in this specification generally have their ordinary meanings in the art, within the context of this invention and in the specific context where each term is used. Certain terms are discussed below, or elsewhere in the specification, to provide additional guidance to the practitioner in describing the methods of the invention and how to make and how to use them. The scope and meaning of any use of a term will be apparent from the specific context in which the term is used.

The term “Earnings Momentum” (EMOM) refers to the rate of change in earnings growth for an asset (or a group of assets) over a given period of time. As an example, earnings momentum is calculated by comparing the recurring income estimate for a particular asset (or group of assets) with a prior time average scaled by market capitalization. A typical historical window is a 12-week average, but other historical averages can be used.

The term “Relative Strength Indicator” (RSI) is a technical analysis variable that depicts whether an asset, or group of assets, is overbought or oversold relative to its recent trading history. RSI measures the average number of down days (days where the value of the asset, at the end of the day, dropped from its opening value) and up days (days where the value of the asset, at the end of the day, increased from its opening value) for an asset over a particular period (typically 14 days). As an example, the RSI can be calculated by using a 250 day trading history initialization period. A score over 70 is considered overbought, whereas a score below 30 is considered oversold.

The terms “Moving Average Convergence Divergence” (MACD) measures an intersect of a variety of moving averages relating to the price history of an asset (or group of assets). The intersects are scored to indicate likely upward or downward trends in the value of the respective asset. As an example, the MACD variable can be calculated from moving averages (MAVG) of the value of the traded asset and gives an indication of the trend in the value of the particular asset. A discreet value from −3 to 3 is assigned such that an MACD of −3 corresponds to a well defined downtrend, whereas an MACD of 3 corresponds to a well defined uptrend.

The “Institutional Brokers' Estimate System” (IBES) is a rating variable that is an estimate of future earnings for a traded asset (or group of assets) from the IBES database.

The term “Consensus Rating” is a discreet variable on a scale of 1 to 5 corresponding directly with an IBES rating. A Consensus Rating of 5 corresponds to a sell and a Consensus Rating of 1 corresponds to a strong buy.

The term “Composite Factor” is a continuous variable which takes into account factors which analysts tend to underestimate in the IBES rating. The higher the Composite Factor variable, the more likely a stock is to outperform. The Composite Factor estimates when an IBES rating is likely to be right or wrong.

The term “Return on Equity” (ROE) is the net income over average common equity. Net income is latest available fiscal year earnings attributable to shareholders after tax minority interest. Common equity excludes minority interest and is averaged over the last accounting year.

The term “Price to Book” (PBR) is the price of the asset at the time of analysis divided by the cash earnings per share.

The term “Long Term Implied Growth” (LTIG) is the long-term growth discounted in the current asset price. One example uses a 4 state dividend discount model. Steady state assumptions can be made regarding Risk Free Rate, Equity Risk Premium, Payout Ratio and Steady State Nominal Growth.

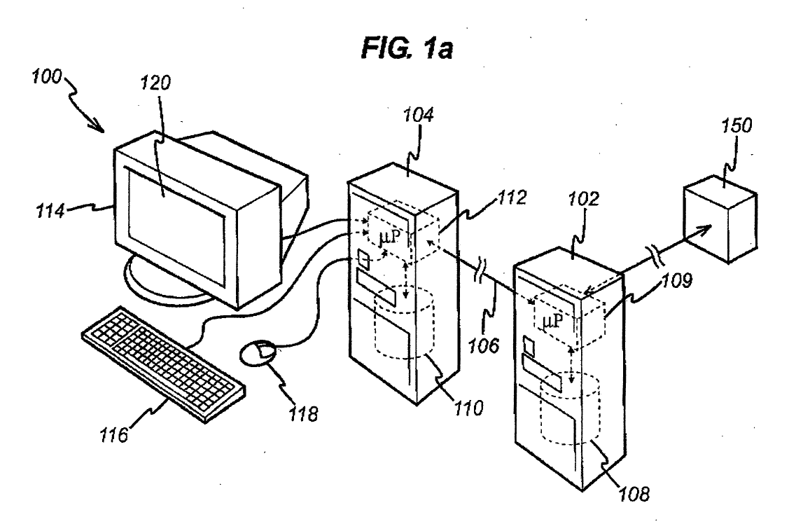

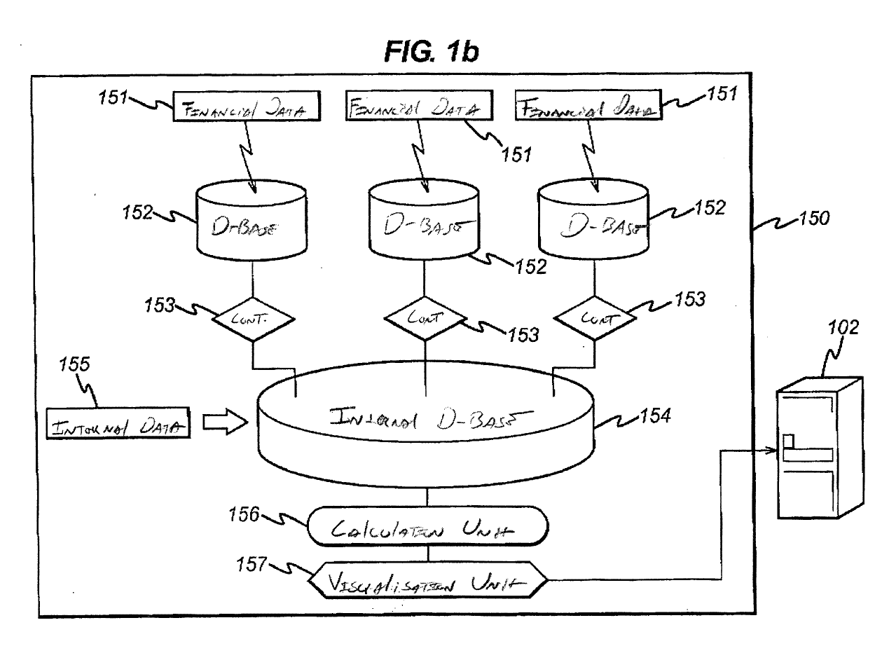

Referring now to FIGS. 1a and 1b illustrating a system 100 comprising a server processing unit 102 and a client processing unit 104. The client processing unit 104 is connected to the server processing unit by a network connection 106. The network connection 106 may be through any type of network such as, for example, a local area network (LAN), wide area network (WAN) or the Internet and may include any number of additional servers provided by Internet Service Providers (ISPs) between the client processing unit 104 and the server processing unit 102. The server processing unit 102 includes server memory 108 in which user interface data, such as interactive web pages, and financial data are stored. A server processor 109 sends and receives data between the server memory 108, the client processing unit 104 and data processing hardware 150.

The client processing unit 104 includes client memory 110 and a client processor 112. A display screen 114 is connected to the client processing unit 104. A keyboard 116 and a pointing device 118 are also connected to the client processing unit 104.

A user interface 120 is generated in the display screen 114 by client processing unit 104. The keyboard 116 and pointing device 118 together constitute interface devices for interacting with the user interface 120 to cause data stored in the client memory 110 to be displayed in the user interface 120. On receipt of a request to the client processor 112 made through the user interface 120 by use of the interface devices, the client processor 112 accesses the client memory 110 or connects to the server processing unit 102 and accesses the server memory 108 to obtain data. The data received by the client processor 112 may be processed by the client processor 112 or simply displayed directly in the user interface 120.

FIG. 1b shows components of the data processing hardware 150. External financial data 151 from external sources is supplied to one or more external databases 152. The external databases 152 supply the external financial data 151 to an internal database 154 via control processes 153. Proprietary internal financial data 155 is also supplied to the internal database 154.

Calculations processing unit 156 requests financial data, which can be external or internal financial data 151, 155, from the internal database 154. The financial data is processed according to predetermined proprietary algorithms to generate further financial data which is to be supplied to the server processing unit 102 for display in the user interface 120. A visualization processing unit 157 generates graphical representations for display in the user interface 120 from the financial data. The graphical representations may be stored in the visualization processing unit 157 for transmitting to the server processing unit 102 at the request of the server processing unit 102 when requested by a user through the user interface 120.

In an alternative embodiment of the present invention, the graphical representations may be generated on-the-fly at the request of the server processing unit 102 and transmitted directly to the server processing unit 102. For example, an embodiment allows the user to select combinations of the external financial data, internal financial data and indicators and request a particular map. The requested map is not retrieved from a stored file but is created at the time of the request to provide the most up-to-date information to the user.

In a further embodiment of the present invention, the visualization processing unit 157 and/or calculations processing unit 156 may be integrated into or form part of the server processing unit 102 such that graphical representations are generated on-the-fly at the server processing unit 102 from financial data. Alternately, the visualization processing unit 157 and/or calculations processing unit 156 may be integrated into or form part of the client processing unit 104 such that graphical representations are generated on-the-fly at the client processing unit 104 from financial data received through the server processing unit 102 from the internal database 154.

The server processing unit 102 may obtain partially processed financial data for transmitting to the client processing unit 104 which may directly correspond to data which is to be represented in a graphical representation in the user interface 120. The client processing unit 104 may then generate the graphical representations directly from the data received from the server processing unit 102. For example, the partially processed data may be the coordinates and type (e.g. category) of financial data to be displayed.

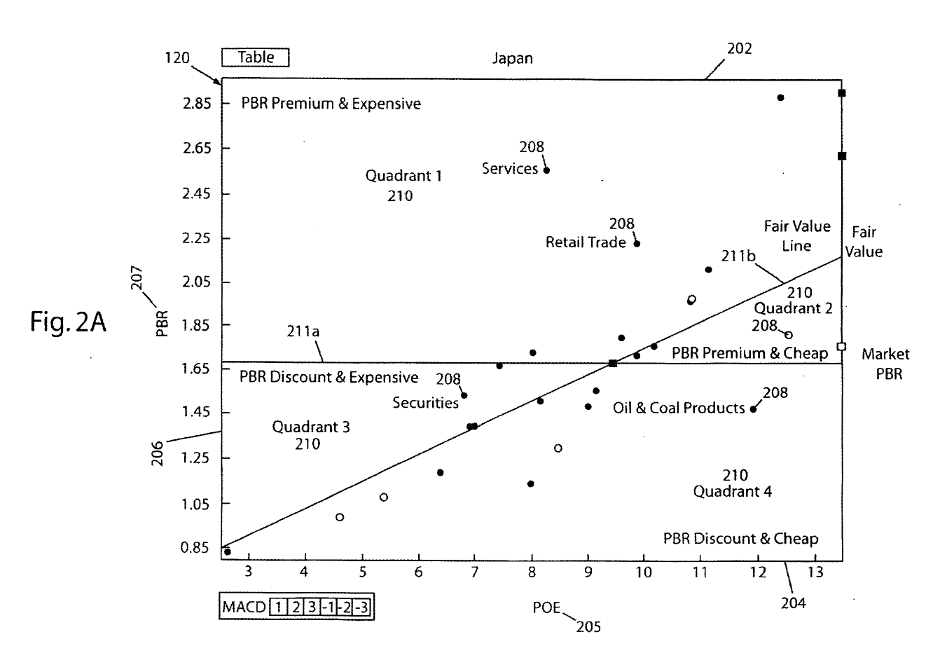

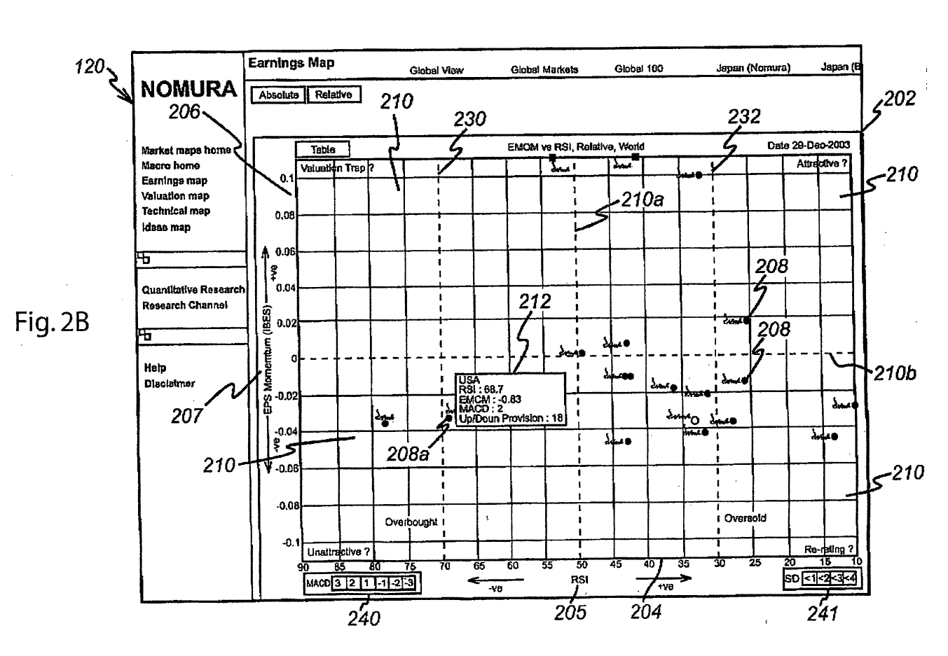

FIGS. 2a and 2b show embodiments of the user interface 120 displayed by the client processor 112 on the display screen 114. The user interface 120 comprises a graphical representation (map) 202 of financial data having a first axis 204 corresponding to a first measurement 205 of financial data and a second axis 206 corresponding to a second measurement 207 of financial data. Icons 208 are plotted against the first axis 204 and the second axis 206. Each icon 208 represents a category of financial data (e.g. an asset, a sector of assets, and all the assets in a nation, region and/or market) and is operable to be activated by the pointing device 118. In the embodiment shown in FIG. 2a, each icon 208 corresponds to a sector in a given market and in the embodiment shown in FIG. 2b, each icon 208 corresponds to a country from which financial data is acquired.

Map 202, as illustrated in FIG. 2a, include segments 210 which are quadrants. Each segment 210 represents attributes relating to financial data (e.g. performance of any of the categories of data represented by the icons 208). The quadrants 210 are defined by line 211a, for example, a market PBR and line 211b, for example, a “fair value” line (the linear best fit incorporating market PBR and ROE). The first axis 204 is a horizontal x-axis (plotting ROE) and the second axis 206 is a vertical y-axis (plotting PBR).

In an embodiment for a valuation map 202, an overvalued asset can be illustrated in quadrant 1, denoting a premium PBR and an expensive asset. An asset located in the first quadrant has a PBR above both market PBR 211a and fair value 211b. Assets located in quadrant 2 have a premium PBR and are considered cheap (inexpensive). The asset is above market PBR 211a but below fare value line 211b. Quadrant 3 is a discounted PBR and an expensive asset. The asset has a PBR below market PBR 211a but above fair value 211b. Assets in the fourth quadrant are discounted PBR and considered cheap. The asset falls below both the market PBR 211a and the fair value 211b.

The graphical representation (map) 202, illustrated in FIG. 2a, comprises a plurality of segments 210 in which the icons 208 are plotted. The segments 210 are quartiles of the Map 202. Each segment 210 represents the attributes relating to financial data (e.g. performance of any of the categories of data represented by the icons 208). The quartiles are bounded by lines 210a, 210b. The first axis 204 is a horizontal x-axis and the second axis 206 is a vertical y-axis.

In the embodiment illustrated in FIG. 2b, a potential sell can be indicated by a low consensus with a positive composite factor value (the upper left-hand quartile in a representation in which composite factor value is on the y-axis and the consensus is on the x-axis). A reliable sell can be indicated by a low consensus with a negative composite factor value (the lower left-hand quartile in a representation in which composite factor value is on the y-axis and the consensus is on the x-axis). A reliable buy can be indicated by a high consensus with a positive composite factor value (the upper right-hand quartile in a representation in which composite factor value is on the y-axis and the consensus is on the x-axis). A risky buy can be indicated by a high consensus with a negative composite factor value (the lower right-hand quartile in a representation in which composite factor value is on the y-axis and the consensus is on the x-axis).

In an alternative embodiment of a second type of graphical representation (map) 202, a valuation trap can be indicated by a high RSI with a positive earnings momentum (the upper left-hand quartile in a representation in which earnings momentum is on the y-axis and the RSI rating is displayed from right (low) to left (high) on the x-axis). An attractive asset can be indicated by a low RSI with a positive earnings momentum (the upper right-hand quartile in a representation in which earnings momentum is on the y-axis and the RSI rating is displayed from right (low) to left (high) on the x-axis). An unattractive asset can be indicated by a high RSI with a negative earnings momentum (the lower left-hand quartile in a representation in which earnings momentum is on the y-axis and the RSI rating is displayed from right (low) to left (high) on the x-axis). A re-rated asset can be indicated by a low RSI with a negative earnings momentum (the lower right-hand quartile in a representation in which earnings momentum is on the y-axis and the RSI rating is displayed from right (low) to left (high) on the x-axis).

Further, an asset, including a sector, market, nation, and/or region, can be identified as overbought or oversold on map 202. Line 230 designates that an icon to the “left”, i.e., with a high RSI, can be considered overbought by the market. The asset can be considered oversold if its icon 208 is located “right”, i.e. a low RSI, of line 232. Typically, a high RSI is greater than or equal to about 70 and a low RSI is less than or equal to about 30.

The color, size or shape of each icon 208 can represent a further dimension of financial data. There are keys 240, 241 having a plurality of discreet variable levels corresponding to the color, size or shape of the icons in the graphical representation 202. The keys 240, 241 can change depending on the category of financial data being displayed or type of graphical representation (map) 202 generated.

On activation of an icon 208 by the pointing device 118, the client processor 112 modifies the graphical representation 202 by acquiring new financial data corresponding to the category of the activated icon and not already displayed in the graphical representation (map) 202 from the server memory 108. The new financial data is displayed in a data component 212 alongside the activated icon 208a. The data component 212 is a rectangular box (i.e., hover box) with an alphanumeric representation of the second data in the form of a table containing the new financial data.

In an alternative embodiment of FIGS. 2a and 2b, the new financial data may be pre-loaded onto the client memory 110 from the server memory 108 and obtained directly from the client memory 110 by the client processor 112 on activation of an icon 208.

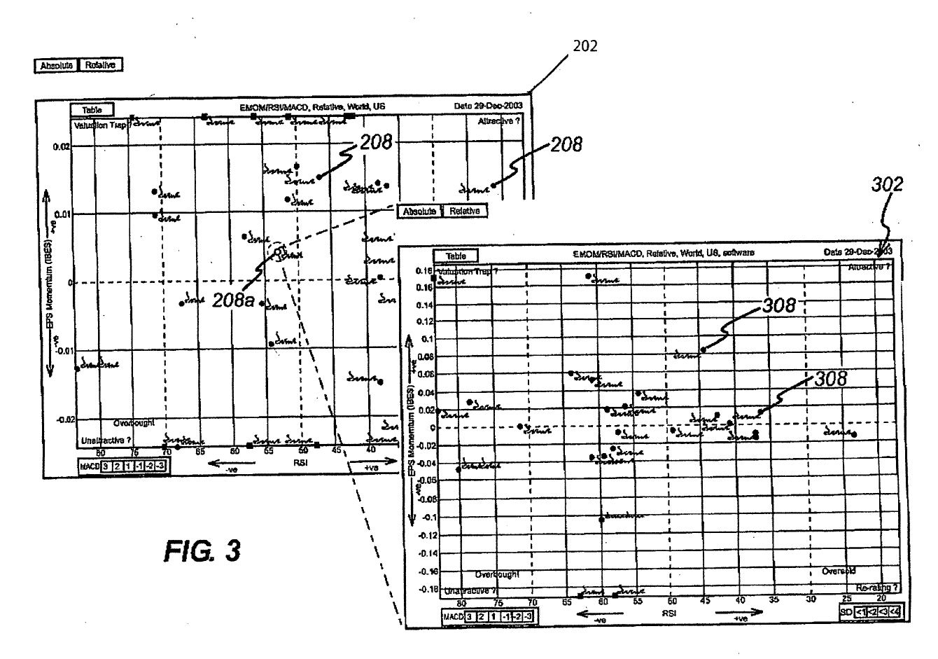

FIG. 3 shows another embodiment of the user interface 120 displayed by the client processor 112 on the display screen 114.

On activation of an icon 208 by the pointing device 118, the client processor 112 modifies the graphical representation (map) 202 by acquiring new financial data corresponding to the category of the activated icon and not already displayed in the graphical representation (map) 202 from the server memory 108. The new financial data is obtained in the form of a new graphical representation (sub-map) 302 from the server memory 108. A plurality of new icons 308 is plotted in the new graphical representation (sub-map) 302 and each new icon 308 corresponds to a sub-category of financial data in the category corresponding to the activated icon 208a. In the embodiment shown in FIG. 3, each sub-category of data represented by the new icons 308 corresponds to an industry in a country corresponding to the activated icon 208a.

In an alternative embodiment of FIG. 3, on activation of an icon 208, the new financial data may be obtained directly from the server memory 108 as raw data values and processed by the client processor 112 to plot the data values in a new graphical representation 302 generated directly by the client processor 112.

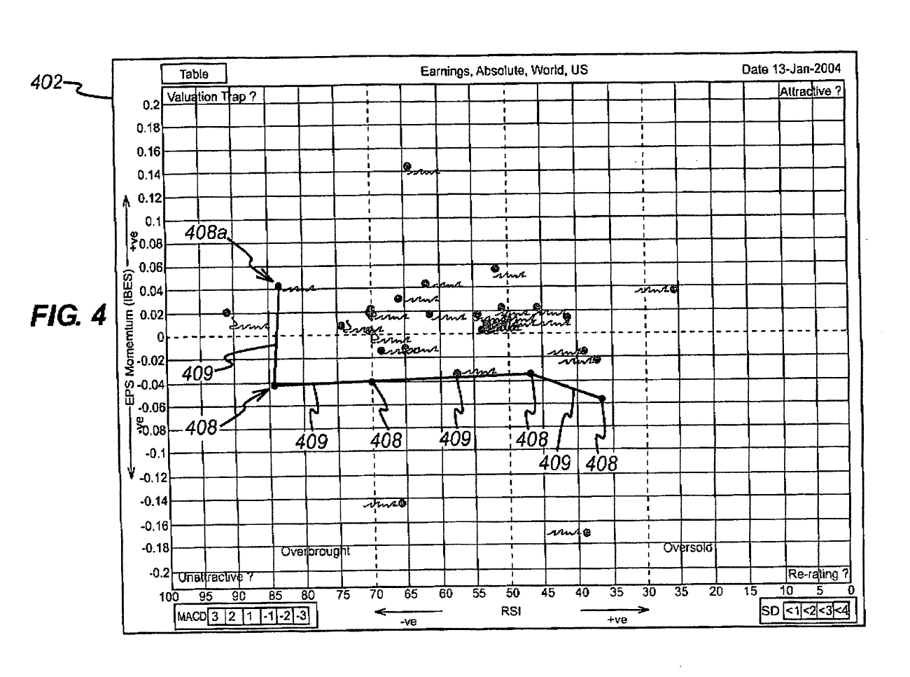

FIG. 4 shows a further embodiment of the user interface 120 displayed by the client processor 112 on the display screen 114. When an icon 408a is activated by the pointing device 118, the client processor 112 obtains historical financial data for the category corresponding to the activated icon 408a and plots icons 408 corresponding to the historical data in a historical graphical representation (historical movement map) 402. The icons 408 are linked by lines 409 showing the route the category of data corresponding to the activated icon 408 has taken as a function of time to arrive at its present position in the graphical representation 202, 302, 402. The lines 409 represent a further dimension in the multi-dimensional historical graphical representation (historical movement map) 402. A moving pointer (not shown), such as an arrow icon, can be animated along the line showing the historical progression of the financial data over a given time period.

Activation of an icon 208, 308, 408 with the pointing device 118 in any one of the embodiments of FIGS. 2a and 2b is completed by moving a pointer on the display screen 114 with the pointing device 118 and by any one of pressing a button on the pointing device 118 or pressing a key on the keyboard 116. The alternative graphical representations 208, 308, 408 of FIGS. 2a, 2b, 3 or 4 may be obtained through allocation to a particular button or key or activation sequence. Alternatively, the pointer may simply be moved over an icon 208, 308, 408 to activate it.

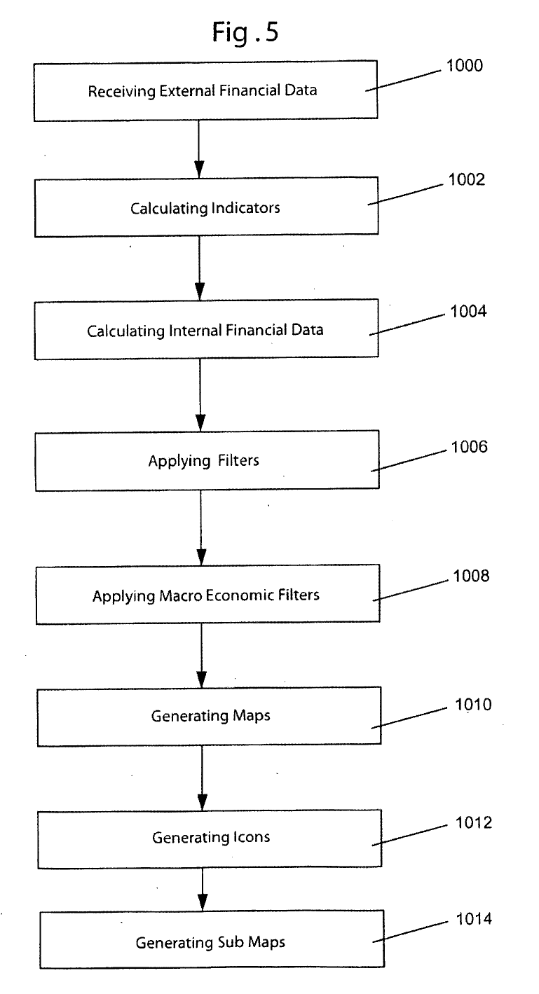

FIG. 5 illustrates the method by which the external and internal financial data 151, 155 are input, processed and displayed on a map. A map is a multi-dimensional representation of financial data. A typical map 202, 302, 402 contains one type of data plotted against another. An added dimension is the color, shape and size of the icon 208, 308, 408. Further dimensions to the data include the numerous sub-maps that can be generated for each icon 208, 308, 408. The user can “drill down” through any map to get further analysis and all the way down to the raw data that generated the icon 208, 308, 408.

The method includes receiving external financial data 151 from third-party providers (step 1000). External financial data 151 relates to, for example, trading information on individual assets (e.g., stocks, bonds, and commodities) from one or more markets both national and international, market information and indices, and other financial indicators (e.g., interest rates, inflation, unemployment, crop reports, and weather trends). External financial data 151 includes, for example, up to the minute asset prices from any or all of the world markets, the Dow Jones Industrial Average, the Standards and Poor's 500 Index (S&P 500), and information from reporting agencies (e.g., Bloomberg, Moody's, Reuters, Telekurs, Exshare, Fitch, Riskmetrics, Russell, Starmine, and Worldscope).

Calculations can be performed on the external financial data 151 to generate one or more indicators (step 1002). The ROE, EMOM, RSI, MACD, PBR, and LTIG are examples of indicators calculated for the asset, sector, and market, as applicable. Calculations for certain indicators, e.g., PBR, are uniform across the financial industry. Calculations for other indicators, e.g., ROE, RSI and MACD, can vary across the financial industry depending on the view of the organization performing the calculation. The basic formula remains the same, however, additional factors or changing the length of time over which asset information is included alters the results.

Internal financial data 155 can be calculated by proprietary calculations of the specific organization and may not be used by other financial analysts (step 1004). Internal financial data 155 can be generated from one or more of the external financial data 151 and the indicators.

Filters can be applied to the external financial data 151, internal financial data 155, and the indicators (step 1006). Filters sort all the financial data and the indicators into numerous categories. For example, a Macro Filter accumulates GDP, inflation and interest rate information. A Valuation Filter sorts out ROE, PBR and LTIG and an Earnings Filter sorts EMOM and the up and down movement of the asset. A Technical Filter sorts RSI, MACD and Stochastic information. Macro Economic filters can also be applied (step 1008). The macro economic filters can apply both known and assumed conditions and predictions to further filter the data.

The filtered data can be used to generate maps 202, 302, 402 which are visual representations of particular external financial data, internal financial data and indicators usually plotted against other external or internal financial data or indicators (step 1010). Typical maps can be a Valuation Map (PBR vs. ROE and Revision, MACD or Consensus Rating) (see, FIG. 2a); an Earnings Map (EMOM vs. RSI and MACD), (see, FIG. 2b); and an Ideas Map (Consensus Rating vs. Composite Factors and trading pairs; Market Signals vs. Analyst; and 20 day Order Imbalance vs. 1 day Order Imbalance and Consensus Rating). Maps 202, 302, 402 can be generated for any asset, sector, or market on the national, regional, or global level. For example, the national markets in one or more regions (North America, Europe, Asia) or countries can be plotted together, the same sector globally can be plotted together (i.e. the steel industry in the U.S. as compared to the steel industry in Great Britain and Japan), and sectors can be plotted against each other (i.e. software and steel).

Further, in generating the map 202, 302, 402 of one type of data verse another, the individual icons 208, 308, 408 can be generated to reflect and third type of external financial data, internal financial data, or an indicator (step 1012). Icons can have differing color, shape, and/or size to reflect the coding with additional data. For example the range of MACD between −3 and 3 can represent a range of colors, to add to the data displayed on user interface 120.

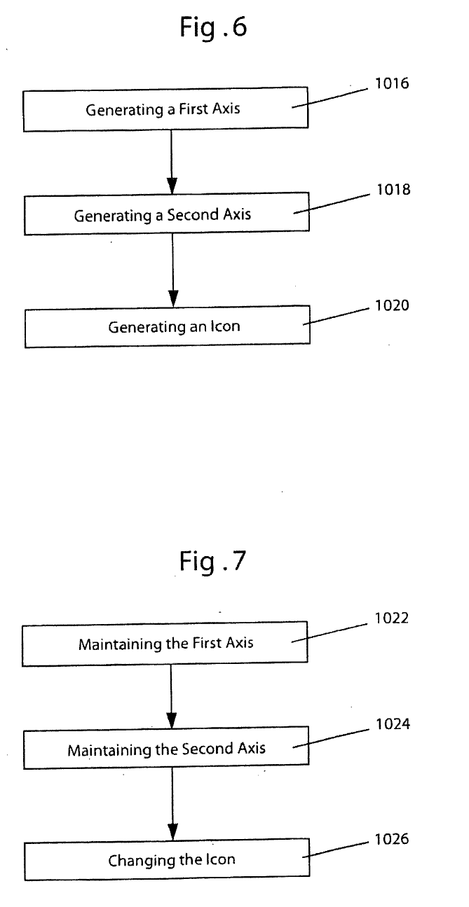

Illustrated in FIGS. 2a, 2b and 6, the method of generating the map can further include generating a first axis 204 representing one of the external financial data, the internal financial data and the indicator (step 1016) and generating a second axis 206 representing one of external financial data, the internal financial data and the indicator (step 1018). Further, the method generates an icon 208 representing one of the external financial data, the internal financial data and the indicator (step 1020). The data represented by the icon, in one embodiment, is not reflected in an axis on the map and is presented in a key 240, 241. Thus, at least three different types of data can be plotted on one two dimensional map. The use of the icons allows more detailed analysis of more complex asset trading strategies.

Once map 202 is generated, sub-maps 302, 402 can be generated automatically or upon user request (step 1014). Sub-maps 302, 402 typically contain more detailed or focused information than the initial map 202. Sub-maps 302, 402 can contain “raw” data (external financial data 151, internal financial data 155, and indicators). However, in one embodiment sub-maps 302, 402 can be generated using the same method as maps 202. For example, if a user selects an Earnings Map comparing world markets, the user can select a sub-map of an individual country or region. The country or region sub-map is also a map a user could have selected initially and the user is not necessarily required to select one type of map to get to a sub-map.

For example, FIG. 2a illustrates a Valuation Map for the Japanese Market, all sectors, and FIG. 2b is an Earning Map 202 for all world markets, all sectors combined. FIG. 3 illustrates a sub-map 302 of the Earnings Map 202 of FIG. 2b. Sub-map 302 illustrates the U.S. market, software sector.

Regarding FIG. 7, an embodiment to create a sub-map is illustrated. The method includes maintaining the representation of the first axis (step 1022) and maintaining the representation of the second axis (step 1024). Typically, the user is “drilling down” from a “higher level” of data to a “lower level” of data and wants the lower data on the same type of map. FIG. 3 illustrates a global Earnings Map 202 for all world markets, all sectors combined with a first axis 204 representing RSI 205 and the second axis 206 representing EMOM 207. Icons 208 represent individual nations or regions and the map shows how all the assets in one nation or region fare against all the assets in another nation or region. Sub-map 302 keeps the first and second axes 204, 206 and changes the icon to represent at least one of a different asset, sector, region, and market (step 1026). The sub-map remains an Earnings Map comparing RSI vs. EMOM and icons 308 have switched from representing nations or regions to individual software companies traded in the U.S. market. The process can also be reversed, where the user initially selects an Earnings Map of the U.S. software sector and drills up to a global Earnings Map, all world markets.

For an embodiment of the sub-maps, the data used for the first and second axes can remain the same, but the scale can differ between the map and the sub-map. For example, in FIG. 3, second axis displaying EMOM ranges from greater than 0.02 to greater than −0.02. Sub-map 303 EMOM scale is between 0.18 to −0.18. Alternately, the scale can remain the fixed between the map and the sub-map.

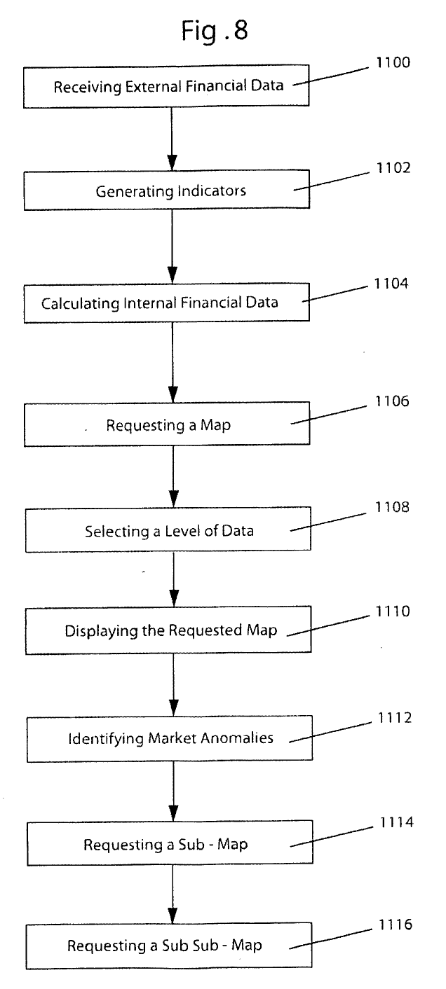

FIG. 8 illustrates another embodiment of preparing map 202, 302. External financial data 151 can be received from third-party providers (step 1100), including trading information on individual assets from one or more markets, market information and indices, and other financial indicators. One or more indicators are generated by performing calculations on the external financial data 151 (step 1102). The ROE, EMOM, RSI, MACD, PBR, and LTIG are examples of indicators calculated for the asset, sector, and market, as applicable.

Internal financial data 155 can be calculated by proprietary calculations of the specific organization (step 1104). Internal financial data 155 can be generated from one or more of the external financial data 151 and the indicators.

A request from the user is received to display external financial data filtered by one or more indicators (step 1106). The user requests a particular map, which can be pre-set, for example the Earnings Map and the Valuation Map, or the user can select the particular data to be displayed on particular axes. The user can request the “level” of external data 151 to be displayed, for example, global or regional and sector or individual assets (step 1108). Icons 208 can be generated to display the requested map (step 1110). From the map, at least one of an inflection point (a.k.a. turning point), an outlier, and a market anomaly can be identified (step 1112).

The user can select icon 208 and request a sub-map (step 1114). Sub-maps typically contain more detailed or focused information than the map. Sub-maps can contain the same or different “raw” data (external financial data 151, internal financial data 155, and indicators). For example, if a user selects an Earnings Map comparing world markets, the user can select a sub-map of an individual country or region. The country or region sub-map is also a map a user could have selected initially and the user is not necessarily required to select one type of map to get to a sub-map.

The user can further select a sub-sub-map (step 1116) that is a further magnification or refinement of the previous sub-map and map. For example, a global sector map can be generated and then a national sector sub-map can be requested. The user can further request an asset level sub-sub-map for assets within the national sector. This is “drilling down” through the data. Embodiments also include “drilling up” through the data. The user can initially select the asset level map as the first map generated and can select “upper” sub-maps containing more details, e.g. the national sector map and the global sector map.

The present invention allows users to interrogate the external financial data quickly and efficiently and to drill up or down and across multiple maps of information, i.e., from the top down (e.g., macro/asset level, geographic regions/markets, sectors) and/or from the bottom up (e.g., asset level) and to filter the data against indicators (e.g., RSI, EMOM, MACD, and LTIG). The maps offer multiple dimensional filtration functionality to enable a comparison between different investment strategies, e.g., growth versus value approach.

Each filter or group of filters of requested indicators applied by the user can cause a recalculation the data for any given map or sub-map of information. Users can visualize the market rotation prevailing in their areas of investment interest and to quickly identify market anomalies, (for example, inflection/turning points, outliers, and catalysts of change).

An aspect of the above embodiment is a method to generate requested maps, sub-maps and sub-sub-maps by generating the first and second axes and generating icons. The axes and/or scales can remain the same through the maps, sub-maps and sub-sub-maps while the icons change at every level to indicate a different asset, sector, nation, region or market. Alternately, a user can select a sub-map have different axes, scales and icons, for example, switching from an Earnings Map to a Valuation Map, depending on the user's request.

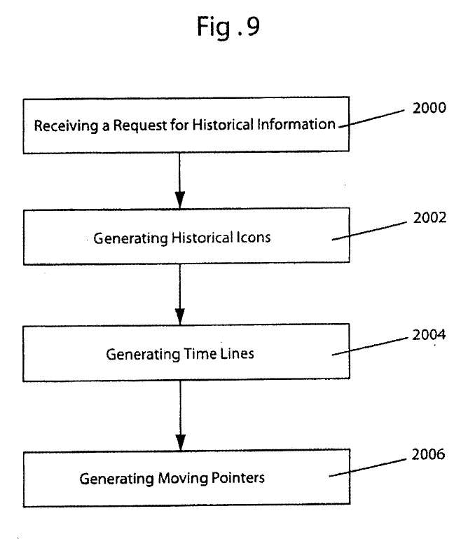

In another embodiment, a method to generate a historical movement map is illustrated in FIG. 9. A user selects an icon 208, 308 for which the user wants historical movement information and that selection is received by server processing unit 102 (step 2000). The user selection can include how much historical information is required (i.e., how far into the past should the map “look back”). Examples of historical maps 408 can be 1 to 10 years of past data (icons 408 representing months or years of data), 3 months of past data (icons 408 representing weekly data), 1 month of past data (icons 408 representing weekly data), the previous week of past data (icons 408 representing daily data), or daily data (icons 408 representing hourly data). The historical financial data is made up of previously received external financial data 151, internal financial data 155 and previously calculated asset information. The information can be stored in internal database 154 or in client memory 110, or both.

Historical icons 408 are generated using the historical data (step 2002) and plotted on the requested historical map 402. The icons can represent multiple time periods that require additional calculations beyond retrieving the necessary data from the storage database. The accumulated historical data is plotted and icons 408 can represent multiple days and weeks.

Historical time lines 409 can connect the historical icons 408 in time order, from oldest to youngest. Lines 409 are generated (step 2004) and indicate the direction the asset “traveled” in the historical map 408 to arrive at its current position 408a on map 202, 302. For example, FIG. 4 illustrates asset icon 408a in its current position. Icons 408 and lines 409 indicate that the asset moved from having a positive RSI to a negative RSI and also its EMOM increased. Visually, icon 408 moved from right to left and up on map 402. The illustrated historical map is simplified and a typical asset has sharper historical movements in all directions, typically in a small range on the historical map 402.

To clarify the exact historical path, a moving pointer (not illustrated) is generated to move from the oldest historical icon 408, across lines 409 to the most recent icon 408a to provide a visual representation of the movement of the icon 408 (step 2006).

The methods above, including the required calculations, can be performed at any point in system 100, including server processing unit 102 and client processor 112, or by a separate processing unit (not illustrated) networked over network connection 106 to one or both of the server and client processing unit 102, 104. All the required storage and calculations can be done at the server level to keep from burdening the client unit. However, client memory 110 may have enough storage and client processor 112 may have enough processing capacity to perform all the tasks necessary for the above steps. Once the necessary data is acquired client processing unit 104 does not need network connection 106 to generated requested maps.

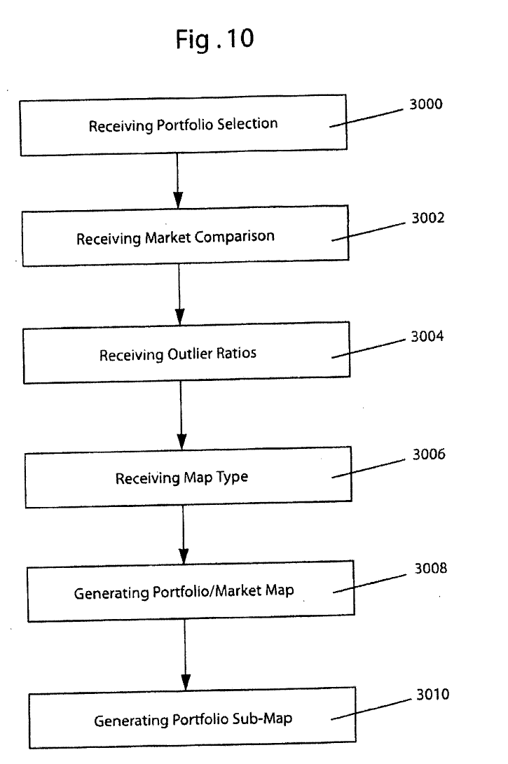

The embodiments above analyze the market data as a whole to help a user select assets to invest in. FIG. 10 illustrates a method to compare a user's existing portfolio of assets against the performance of the market or sector as a whole or against the user's own assets. A user selects a group or portfolio of assets and that selection is received by the server (step 3000). The user can select a mix of assets to place in a portfolio, or the portfolio can be automatically generated given the nature of the assets in the portfolio and the standard categories the assets are defined in. For example, if the user owns stock in BankAmerica, Citigroup, the Bank of Yokohama and the Hachijuni Bank a number of portfolios can be generated. Possible portfolios are “world banks”, containing all four assets; “U.S. banks” (Bank America and Citigroup) and “Japanese Banks” (Bank of Yokohama and the Hachijuni Bank). The manual input of the assets can be done in many ways, including inputting the ticker symbol or any other unique identifier used to identify the asset (e.g. Reuters, Bloomberg, Quantic, Quick, SEDOL (6 digit) and SEDOL (7 digit)), or clicking and dragging to place the asset in the correct portfolio.

The user can select the markets the portfolio should be compared to and that choice is received by the server (step 3002). For example, the portfolio can be compared to the Global Markets, Global Sectors, top 100 Global Assets, and the same markets, sectors and assets at the regional and national levels. The map can be generated automatically given the nature of the asset. For example, the World Banks portfolio can be compared to the Global Sectors and/or all Global Banks to determine how the assets in the banking sector are doing relative to other assets similarly grouped. The user also can define an outlier ratio that defines the proportion of stocks that are outliers on a map (step 3004). The larger the value, the more outliers can be plotted on the map. One embodiment only plots outlier ratios between 0 and 1.

The user selects the type of map to generate (step 3006) and the system generates the portfolio map using the portfolio, market and outlier information (step 3008). FIG. 8 illustrates portfolio map 502 where the user selected portfolio “Japan Banks” 503 to be plotted relative to all of Japan on an Earnings Map. The icons related to the portfolio assets 508a can be a specific color, shape or size, while the icons representing assets not in the portfolio 508b can have a different color, shape, or size. Portfolio sub-maps can also be generated automatically or upon user request (step 3010).

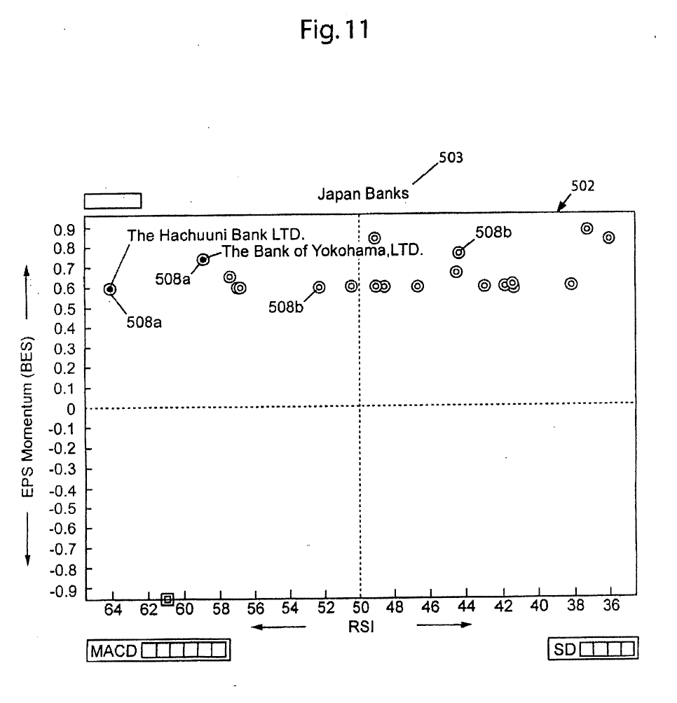

FIG. 11 illustrates the example where portfolio icons 508a are larger than icons 508b. Any of the maps and sub-maps defined above can be chosen to generate a particular portfolio map 502. All of the information available on any of the non-portfolio maps 202, 302, 402 can be provided in the portfolio map 502, including drill downs to more specific data and historical movement maps 402.

Numerous maps can be generated by the present invention. Examples of maps include an Earnings Map with an Earning Historical Movement Map. Earnings Maps can be generated based on the combination of two or more external financial data, internal financial data and indicators, including EMOM, RSI, MACD, Price/Earnings (PE), First term PE ratio, 5 year PE ratio, Peg ratios, Operating margin, Recurring margin, Net margin, Sales, Net income, Operating income, Recurring income, and Cash flow.

Another type of map is a Valuation Map which can include a ROE map, a LTIG map, a Life cycle of earnings (LCOE) map, a Growth verse Value map and a Starmine versus Consensus map. Valuation Maps typically cross-reference two or more of external and internal financial data and indicators such as: PBR, Price to Sales (PSR), Price to Cash Earnings Ratio (PCER), Price Earnings Ratio (PR), ROE, Price Earnings Forecast (PEFR), Forecast EPS Growth (FEPSG), EPS growth (EPS), Dividend Yield, Forecast Sales Growth, Sales Growth, Earnings Yield Growth, Sales Yield, Sales Yield Growth, Earnings Yield, ROE multiplied by (1-Payout Ratio), Envisaged, Operating Margin, Net Margin, Tax rate, Sales 10 or 1 year Growth, Labor 10 or 1 year growth, Cogs 10 or 1 year growth, Sga 10 or 1 year growth, Other Operation Expenses Final 10 or 1 year growth, Ebitda 10 or 1 year growth, Deprecation 10 or 1 year growth, Net Interest Income 10 or 1 year growth, Except Pretax Net cr 10 or 1 year growth, Associates pretax 10 or 1 year growth, Other non op Income 10 or 1 year growth, Pretax profit 10 or 1 year growth, Tax 10 or 1 year growth, Minority interest 10 or 1 year growth, Associates After Tax 10 or 1 year growth, After Tax Other Tot 10 or 1 year growth, Net Income Before Extra 10 or 1 year growth, Except After Tax Certified cr 10 or 1 year growth, Operating margin, Ebitda margin, Labor to sales, Deprecation to sales, Net income margin, Tax rate, Interest Expense Total 10 year growth, claim Expense 10 year growth, Prov Loan Losses 10 or 1 year growth, Non interest expenses bk 10 or 1 year growth, Interest expense total 1 year growth, claim expense 1 year growth, Other operational expenses total 10 or 1 year growth, Operating margin 10 year, Ebitda margin 10 year, Labor to sales 10 year, Tax rate 10 year, Net income margin 10 year, Deprecation to sales 10 year, Operational increases 1 year growth, and Net income 10 or 1 year growth.

Other maps include, a Macro Map illustrating two or more macro economic indicators (for example, inflation measures, GDP, commodity prices, leading indicators) to generate, for example, GDP calculators map, Leading indicators aggregator for GDP consensus forecasting map, Yield curve analysis map, Model portfolio map, and an Inflation impact map.

Further maps can be an Ideas Map comparing, Consensus rating, Pairs trading (both Contrarian pair and Consensus pair), Enhanced rating, Order imbalance, and Restructuring (a market impact analysis map) or a Portfolio Map (as described above). A Technical Map (Stochastic maps) and a Corporate Bond Map illustrating Yield to maturity value (e.g. Short term: <3 years, Medium term: 3-7 years, Longer term: 7-15 years, and 15+ years), Indebtedness/ability to pay of corporate bond originator, and Credit rating (e.g. S&P, Moodys).

Another embodiment of the invention allows a user to actively trade through the maps 202, 302, 402, 502. A user viewing maps 202, 302, 402, 502 with an asset trading account, can select an icon 208, 308, 408, 508a, 508b to purchase the asset represented. User account information and a selection menu are displayed allowing the user to select the quantity of the asset to purchase and the current market price. Sub-menus provide transaction confirmation and all appropriate legal notices are required by the place of origin of the user. A user viewing a portfolio map 502 can also sell assets by selecting icon 508a and directing the sale of the asset. Account information and a selection menu are displayed allowing the user to select the quantity of the asset to sell and the current market price. Additional embodiments allow a user to determine profit and loss of a given asset. The system calculates the profit and loss based on the purchase and sale price.

A further trading embodiment allows a user to select sectors from a map and be given a list of available mutual funds that invest in the particular sector of interest. The mutual fund listing can be all mutual funds that invest in that sector or can be filtered automatically by the map the user is on. For example, if the user is viewing a map of Japanese technology companies, the mutual fund list is sorted to display only funds that have at least one asset in the Japanese technology sector. Another embodiment sorts the mutual fund list for funds having assets solely in that sector or market.

Another embodiment is the trade alert system. The system tracks all of the asset trades made by a user and provides helpful pop up alerts before a user's trade becomes final. Alerts can warn of net loss on the trade, or provide analyst hints such as the stock is over valued and might not be the best buy. The alerts can further notify the user of alternate assets that are in the same market or sector that may be a better value to the user.

While there have been shown, described, and pointed out fundamental novel features of the invention as applied to a preferred embodiment thereof, it will be understood that various omissions, substitutions, and changes in the form and details of the devices illustrated, and in their operation, may be made by those skilled in the art without departing from the spirit and scope of the invention. For example, it is expressly intended that all combinations of those elements and/or steps which perform substantially the same function, in substantially the same way, to achieve the same results are within the scope of the invention. Substitutions of elements from one described embodiment to another are also fully intended and contemplated. It is also to be understood that the drawings are not necessarily drawn to scale, but that they are merely conceptual in nature. It is the intention, therefore, to be limited only as indicated by the scope of the claims appended hereto.

1. A method of processing and displaying external and internal financial data, comprising the steps of:
receiving the external financial data;
calculating at least one indicator using the external financial data;
calculating the internal financial data using at least one of the external financial data and the indicator;
applying a filter to at least one of the external financial data, the internal financial data, and the indicator;
generating a map having at least one of the external financial data, the internal financial data and the indicator;
generating an icon having at least one of the external financial data, the internal financial data and the indicator; and
optionally, generating a sub-map.

2. The method of claim 1, wherein the icon also represents at least one of an asset, a sector, a region, a nation, and a market.

3. The method of claim 2, wherein the generating the map step further comprises the steps of:
generating a first axis representing one of the external financial data, the internal financial data and the indicator;
generating a second axis representing one of the external financial data, the internal financial data and the indicator; and
generating the icon representing one of external financial data, the internal financial data and the indicator independent of the first and second axis.

4. The method of claim 3, wherein the generating the sub-map step comprises the steps of:
maintaining the representation of the first axis;
maintaining the representation of the second axis; and
changing the icon to represent at least one of a different an asset, a sector, a region, and a market.

5. The method of claim 1, further comprising the step of applying a macro economic filter to the filter.

6. A method of preparing a market map, comprising the steps of:
receiving external financial data;
calculating an indicator using the external financial data;
calculating internal financial data;
receiving, from a user, a request to display the external financial data filtered by the indicators;
receiving, from the user, a level of the external financial data to be displayed;
displaying the requested levels of the external financial data; and
identifying a market anomaly.

7. The method of claim 6, wherein the market anomaly includes at least one of an inflection point, an outlier and a catalyst of change.

8. The method of claim 6, further comprising the steps of:
receiving, from the user, a request for a sub-map;
generating the sub-map; and
optionally, receiving from the user, a request for a sub-sub-map.

9. A method for generating a historical movement map comprising the steps of:
receiving, from a user, a selection for an icon;
receiving, from the user, a request for an amount of historical information;
generating at least two historical icons from the historical information;
generating a historical time line connecting the historical icons; and
generating a moving pointer moving from an oldest historical icon to a most recent historical icon.

10. The method of claim 9, further comprising the step of connecting a plurality of historical icons with a plurality of historical time lines in time order, from oldest to youngest.

11. The method of claim 9, wherein the amount of historical data can include at least one of, three months of the historical information, one month of the historical information, and a week of the historical information.

12. A method to compare an existing portfolio of assets to a market on a map, comprising the steps of:
selecting, by a user, a portfolio of assets;
selecting, by the user, the market;
defining an outlier ratio;
selecting, by the user, a map type;
generating the map using at least one of the portfolio of assets, the market and the outlier ratio; and
optionally, generating a sub-map.

13. A system for analyzing financial data over a network, comprising:
a server processing unit storing financial data;
a client processing unit connected to the server processing unit;
a display screen connected to the client processing unit; and
manipulation means,
wherein one of the processing units is adapted to generate a user interface on the display screen including a visual representation of first financial data received from the server processing unit, the visual representation comprising a plurality of first icons, each first icon representing a category of the first financial data and operable to be activated by the manipulation means, the arrangement of each first icon in the visual representation corresponding to first financial data associated with the category represented by the each first icon, and
wherein on activation of an icon, the client processing unit requests second financial data from the server processing unit corresponding to the category of the activated icon other than the first financial data represented in the arrangement of the first icons and displays the second financial data in the visual representation.

14. The system as claimed in claim 13, wherein the financial data received from the server processing unit by the client processing unit is at least one of raw financial data and graphical data including the visual representation;
wherein the client processing unit is adapted to generate the visual representation from the raw financial data; and
wherein the client processing unit is further adapted to display the visual representation from the graphical data in the display screen.

15. The system according to claim 13, wherein the second financial data is displayed in a data component corresponding to the activated icon wherein the data component is at least one of an alphanumeric representation of the second data and a table containing the second financial data.

16. The system according to claim 13, wherein the second financial data is represented by a plurality of second icons plotted in the visual representation on activation of a first icon, each second icon corresponding to a sub-category of financial data in the category corresponding to the activated first icon.

17. The system according to claim 16, wherein each category of financial data represented by at least one of the first icon and the second icon is distinguishable by at least one of a color, a size and a shape.

18. The system according to claim 17, wherein the visual representation comprises a plurality of axes including:
a first axis corresponding to a first measurement of financial data; and
a second axis corresponding to a second measurement of financial data,
wherein the first icons are plotted against the first axis and the second axis according to the first measurement and the second measurement of the first financial data corresponding to the first icons.

19. The system according to claim 16, wherein the plurality of axes includes:
a first axis corresponding to a first measurement of financial data; and
a second axis corresponding to a second measurement of financial data,
wherein the first icons are plotted against the first axis and the second axis according to the first measurement and the second measurement of the first financial data corresponding to the first icons, and
wherein the second icons are plotted against the first axis and the second axis according to the first measurement and the second measurement of the second financial data corresponding to the second icons.

20. The system according to claim 13, wherein a plurality of first icons represents a single category of financial data, each first icon representing the financial data corresponding to the single category at a specific time and are linked by a line in time order.

21. The system according to claim 16, wherein a plurality of second icons represents a single sub-category of financial data, each second icon representing the financial data corresponding to the single sub-category at a specific time.

22. A method of handling financial data, comprising the steps of:
displaying a plurality of icons in a visual representation on a display unit, each icon corresponding to a category of financial data, the arrangement of each icon in the visual representation corresponding to first financial data associated with the category represented by the each icon;
on activation of one of the icons with a pointing device, modifying the visual representation such that second financial data corresponding to the category of the activated icon in addition to the first financial data represented in the arrangement of the icons is displayed in the visual representation, comprising the steps of:
displaying the second financial data in a data component corresponding to the activated icon; and
plotting a plurality of second icons in the visual representation on activation of a first icon, each second icon corresponding to a sub-category of financial data in the category corresponding to the activated first icon.
